(19) United States
(12) Patent Application Publication
(10) Pub. No.: US 2023/0358421 A1
(43) Pub. Date: Nov. 9, 2023

(54) SYSTEM AND METHOD FOR PORTABLE HUMIDIFIER FOR HARD WATER

(71) Applicant: Ryan BONDYRA, Calgary (CA)

(72) Inventor: Ryan BONDYRA, Calgary (CA)

(21) Appl. No.: 18/144,712

(22) Filed: May 8, 2023

Related U.S. Application Data
(60) Provisional application No. 63/339,650, filed on May 9, 2022.

(51) Int. Cl. F24F 6/06; B08B 3/08; B08B 9/08; B08B 3/04

(52) U.S. Cl. CPC F24F 6/06; B08B 3/08; B08B 9/08; B08B 3/041; F24F 2006/008

(57) ABSTRACT

There is provided a system comprising a reservoir containing fluid, a basin fluidly connected to said reservoir, a drum having a plurality of discs, and an exhaust. The discs are partially submerged in said basin and are rotated by a drum motor. A fan intakes air via an inlet and passes air through the drum and to an exhaust.

### CROSS-REFERENCE TO RELATED APPLICATIONS

This claims the benefit of U.S. Provisional Patent Application No. 63/339,650, filed on May 9, 2022, the entire contents of which are incorporated by reference herein in their entirety.

### FIELD

This relates generally to humidifiers, and more particularly to portable evaporative humidifiers.

### BACKGROUND

Conventional portable humidifiers suffer from numerous drawbacks, particularly when used in connection with hard water. Hard water is tap water containing a relatively high concentration of dissolved minerals (typically calcium carbonate, but other minerals are possible). Portable humidifiers may be ineffective and/or suffer from elevated operating costs when used with hard water.

Conventional portable humidifiers are typically noisy, energy inefficient, difficult to maintain, and may not be able to provide the desirable output of humidity for a dry climate (e.g. 10 L per day) to maintain a desirable level of humidity (e.g. 40%) in an area (e.g. an area greater than 500 square feet). Some solutions to hard water humidification exist, but require a furnace-mounted humidifier unit. As such, for areas without a furnace, or areas in which the furnace is inaccessible or prohibited from being accessed (e.g. rental units), furnace-mounted humidifier units are not an option.

It would be desirable to provide a portable humidifier which is one or more of capable of working with hard water, easy to maintain, less noisy during operation, and operates more efficiently than conventional humidifier units.

### SUMMARY

According to an aspect, there is provided a system comprising: a reservoir containing fluid; a basin fluidly connected to said reservoir; a drum partially submerged in said basin, said drum comprising a plurality of discs; a drum motor configured to rotate said drum and said plurality of discs; a fan configured to intake air via an inlet and expel air via an exhaust, said drum being positioned between said inlet and said exhaust; and a fan motor configured to actuate said fan.

According to another aspect, there is provided a method of humidifying an area, the method comprising: rotating, via a drum motor, a drum comprising a plurality of discs within a basin, said drum partially submerged within a fluid in said basin; activating a fan, via a fan motor, to pass air through said plurality of discs to an exhaust.

Other features will become apparent from the drawings in conjunction with the following description.

### BRIEF DESCRIPTION OF DRAWINGS

In the figures which illustrate example embodiments,

FIG. 1 is a perspective view of an example humidifier in accordance with some embodiments;

FIG. 2 is a perspective view of the example humidifier of FIG. 1 with the case removed;

FIG. 3 is a perspective view of the example humidifier of FIG. 2 with the air shroud removed;

FIG. 4 is a top view of an example humidifier in accordance with some embodiments;

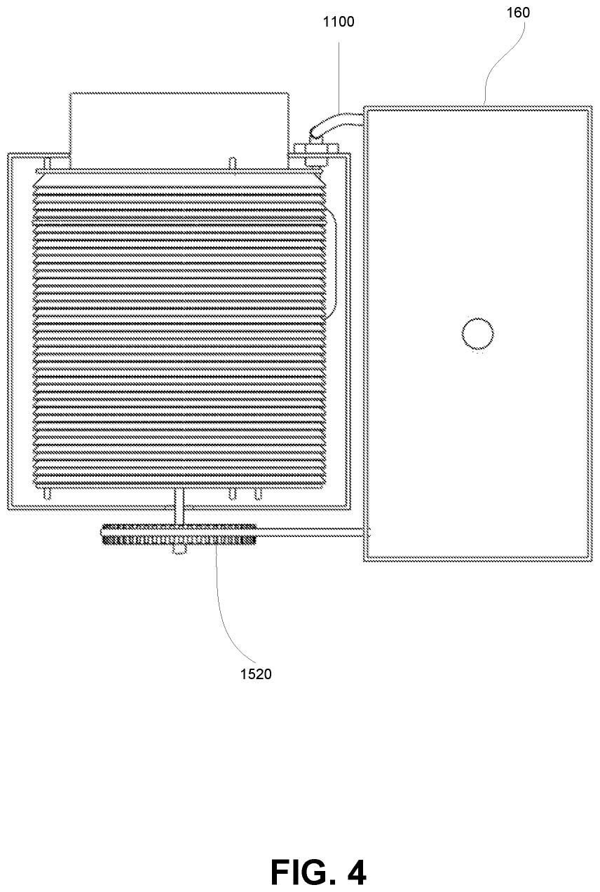

FIG. 5 is a partial front view of an example humidifier in accordance with some embodiments;

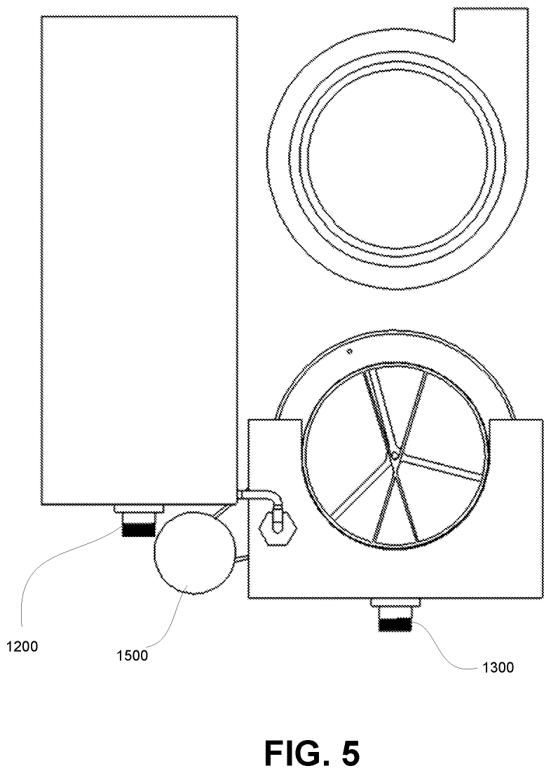

FIG. 6 is a perspective rear review of an example humidifier in accordance with some embodiments;

FIG. 7 is a perspective view of a drum in accordance with some embodiments;

FIG. 8 is a perspective view of a DC belt drive in accordance with some embodiments;

FIG. 9 is a perspective view of a drum in accordance with some embodiments;

FIG. 10 is a front view of a disc in accordance with some embodiments;

FIG. 11 is a side view of a single profiled disc, in accordance with some embodiments;

FIG. 12 is a perspective view of a single profiled disc in accordance with some embodiments; and

FIG. 13 is a diagram of example components of a computing system.

### DETAILED DESCRIPTION

Some embodiments relate to a portable humidifier having a gravity-fed water distribution system. In some embodiments, the water distribution system drains into a basin containing discs. In some embodiments, the discs rotate. In some embodiments, the discs may be profiled. In some embodiments, a blower and/or fan may draw air through the discs and exhaust humid air into an area.

There are numerous design strategies for humidifiers. Ultrasonic humidifiers have high moisture output, are power efficient, and operate with low noise. Ultrasonic humidifiers emit fine water particles into the air, which evaporate quickly. As the water evaporates, mineral particles may be left airborne, leaving a fine dust which settles in the vicinity of the ultrasonic humidifier. Such dust may have negative health effects for users, and may be difficult to clean up. Distilled water may be used in lieu of tap water, but this increases the operating costs associated with the humidifier, and is impractical particularly if higher volumes of water (e.g. more than 10 L) are required per day to maintain the desired level of humidity.

Warm air/steam humidifiers function by heating water to the boiling point, thereby releasing steam into the surroundings. Steam humidifiers suffer from high operating costs due to the electricity required to heat/boil the water. Moreover, the on/off duty cycle nature of warm air/steam humidifiers implies that a portion of electricity is wasted to heating a room when water in the basin cools between heating cycles. In addition, condensation and mould issues are common, as there is a tendency to over-humidify the space. Steam humidifiers are also noisy during operation due to the bubbling noises and gurgling of the reservoir, and the heating element may be subject to failure over time due to constant heating/cooling cycles.

Evaporative pad humidifiers use a disposable wicking filter which draws water vertically up from a basin via capillary action. An axial fan may then draw dry air through the wetted wicking filter, thereby expelling humid air into the surroundings. However, mineral build-up over time may reduce the capillary action of the filter, and the filter may be unable to stay fully wetted over time. This causes the evaporative humidifier to be less effective, and can also cause a musty smell to emanate. Wicking filters eventually need to be replaced, which leads to landfill waste and high operating costs over time. Evaporative pad humidifiers also require powerful fans to suck air through the wicking filter, and are therefore typically quite noisy during operation.

Some humidifier designs include a drum which is rotated through a bath of water, which causes the wetted area to remain wet. However, dirt, dust and mineral deposits may accumulate in the basin and can cause performance and/or health issues if not properly maintained. These systems may be challenging to clean due to the complex shapes of parts, resulting in possible health issues. Some designs use the reservoir as the basin which causes the water level in the humidifier to vary; this decreases the overall humidifying efficiency. Some designs may include a gurgle system in which water is drained from the reservoir in batches, which releases bubbles in the water reservoir and results in undesirable gurgling sounds. Such designs may also require increasingly powerful (and noisy) fans to overcome reduced airflow due to the shape of discs and drums involved. Frequently, one motor is used for both the fan and the rotating drum. Vinegar may be used to demineralize the humidifier, which results in the unpleasant odour of vinegar permeating the vicinity of the humidifier due to a single motor being used to rotate the drum and spin the fan.

Some embodiments may provide a robust, cost-effective, silent and practical solution to humidifying a space using hard tap water. Some embodiments may include one or more of a rotating drum of discs, a DC motor to rotate the drum of discs, and a blower/fan. Air may flow from an air inlet through an axis of rotation of the drum, and out through the sides of the discs. A DC motor, and in particular a brushless DC motor, may provide efficient and silent operation, which may result in lower operating costs and quieter operation. In some embodiments, a drain and clean mode may provide users with an effective and easy way to perform maintenance. Some embodiments may be used for air conditioning purposes at greatly reduced energy consumption relative to compressor-based air conditioners.

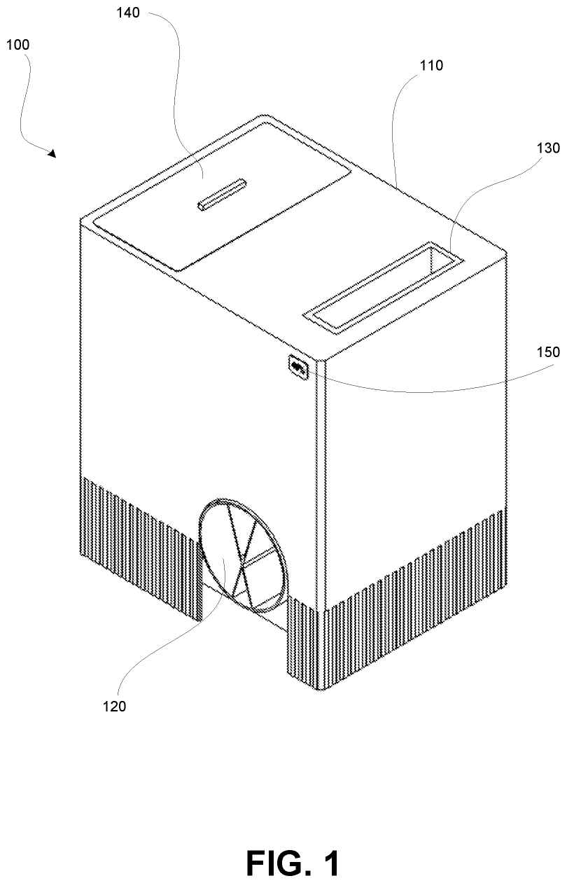

FIG. 1 is a perspective view of an example humidifier 100 according to some embodiments. In some embodiments, humidifier 100 may be suitable for use with hard water. As depicted, humidifier 100 includes an outer case 110, an air inlet 120, an air outlet or exhaust 130, lid 140, and console 150. It will be appreciated that the embodiment depicted in FIG. 1 is merely an example and may include additional or fewer components than depicted. For example, some embodiments might not include display 150.

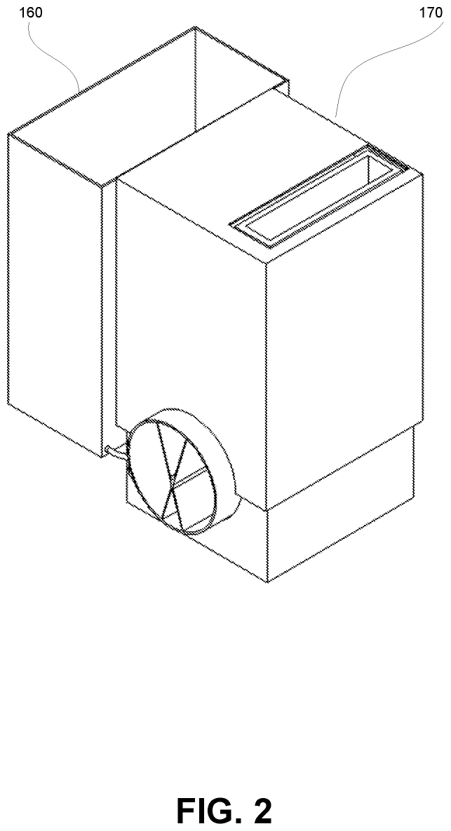

FIG. 2 is a perspective view of humidifier 100 with outer case 110 removed. As depicted, contained within outer case 110 are reservoir 160 and air shroud 170.

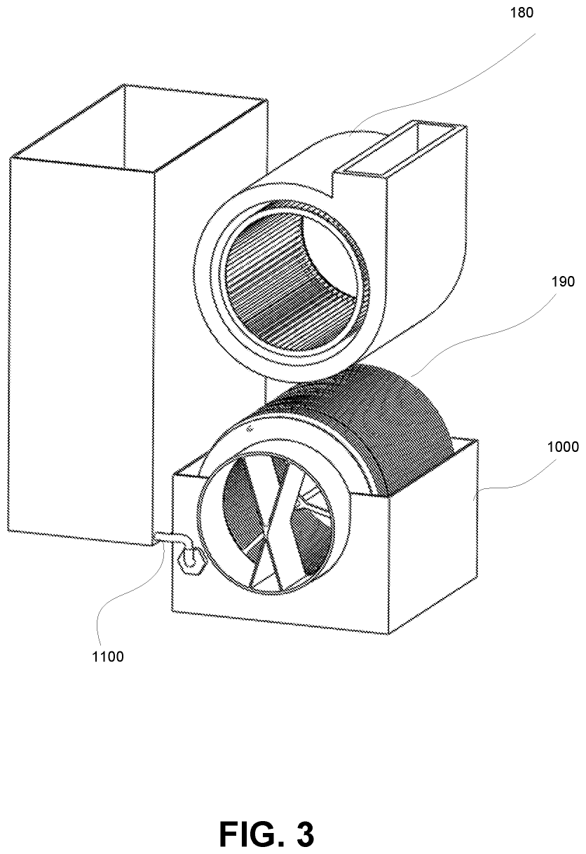

FIG. 3 is a perspective view of humidifier 100 with air shroud 170 removed. As depicted, within air shroud 170 is included fan 180, drum 190, basin 1000, and a tube 1100 connecting reservoir 160 to basin 1000. In some embodiments, blower/fan 180 may mount within air shroud 170, which may ensure air enters substantially only from air inlet 120 and exits through air outlet/exhaust 130. Air shroud 170 may enhance the efficiency of moisture transfer by increasing the amount of air passing through the axis of rotation of drum 190.

A fluid may be added to reservoir 160. In some embodiments, the fluid is tap water. In some embodiments, the fluid is distilled water. Fluid may be added to reservoir 160 using, for example, a bucket or any other suitable container for transporting and dispensing fluids. As depicted in FIG. 3, reservoir 160 may be connected to basin 1000 via a tubed connection 1100. In some embodiments, tube 1100 may be a flexible tubing connection. In other embodiments, tube 1100 may be inflexible.

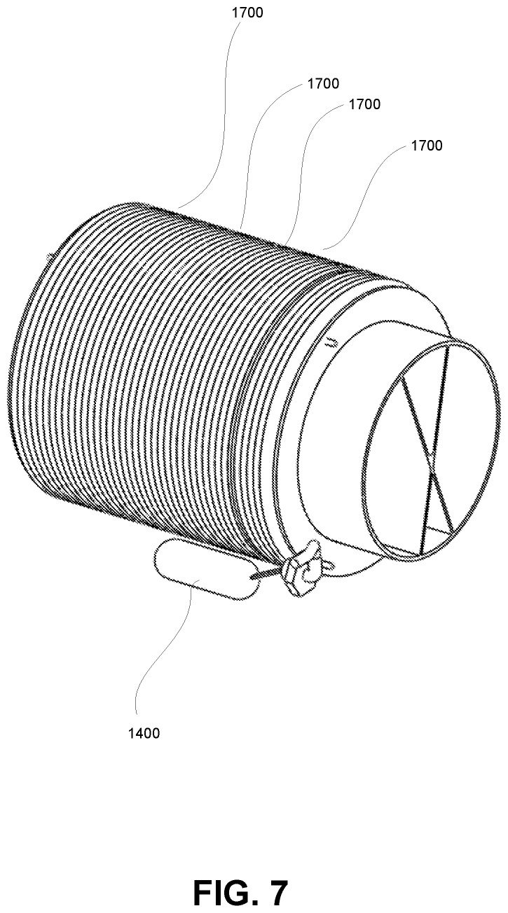

In some embodiments, flow of fluid between basin 1000 and reservoir 160 may be controlled or regulated. In some embodiments, a float valve 1400 (as depicted in FIG. 7) may be used to regulate flow between basin 1000 and reservoir 160. For example, if the fluid level in basin 1000 falls below a threshold, float valve 1400 may open, resulting in fluid being fed by gravity into basin 1000 from reservoir 160.

In some embodiments, fluid flow from reservoir 160 to basin 1000 may be substantially silent. Float valve 1400 may prevent or substantially reduce the occurrence of gurgling sounds, which are undesirable and frequently encountered during operation of other humidifier designs.

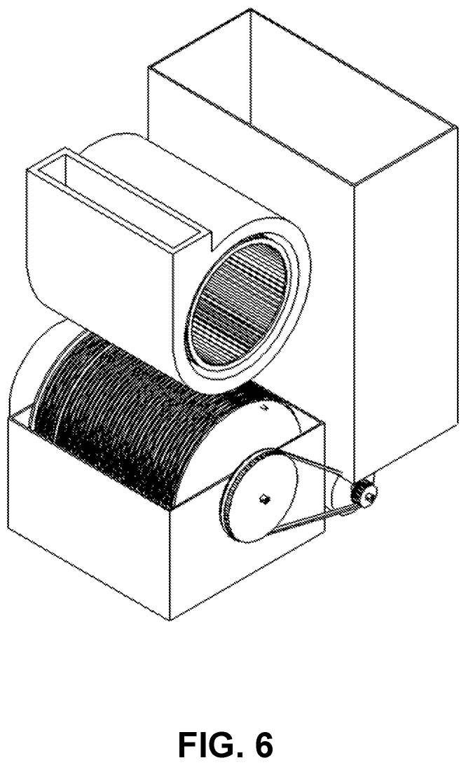

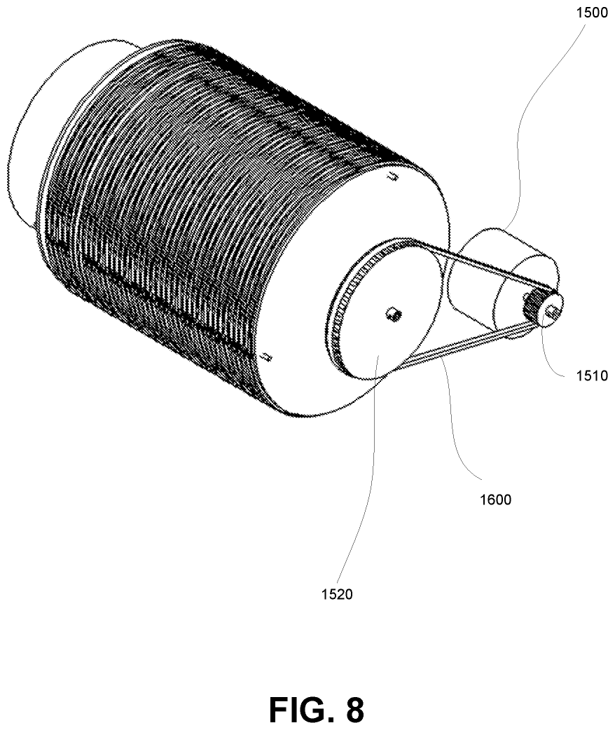

When humidifier 100 is connected to a power source (not shown), blower/fan 180 and drum 190 may begin to rotate. In some embodiments, a power source may include an AC-DC power adapter, which may minimize manufacturing costs and regulatory requirements. For example, in some jurisdictions, pre-certified Class 2 power adapters may reduce regulatory testing requirements. In some embodiments, a battery or other suitable power source may be used. In some embodiments, a single main shaft 1800 holds drum 190 and is mounted to both sides of basin 1000. As depicted in FIG. 6, on a back side of humidifier 100, shaft 1800 may extend past the mount and may be connected to a drum motor 1500. In some embodiments, motor 1500 may be a DC motor. In some embodiments, motor 1500 may be a brushless DC (BLDC) motor. In some embodiments, motor 1500 may be an AC motor. In some embodiments, motor 1500 may be an AC synchronous motor. In some embodiments, shaft 1800 may be connected to motor 1500 via drive belt 1600. As depicted in FIG. 8, motor 1500 may connect to a first gear 1510, which rotates a second gear 1520 connected to main shaft 1800. The gear ratio of first gear 1510 to second gear 1520 may be selected so as to achieve the desired speed and/or power transfer. In some embodiments, drum 190 may rotate at a speed less than 20 rpm. In some embodiments, motor 1500 may include a built-in gearbox.

In some embodiments, motor 1500 is configured to rotate drum 190 at a constant angular speed (i.e. constant RPM). In some embodiments, motor 1500 may rotate drum at a variable speed. As depicted in FIG. 8, a belt drive mechanism using belt 1600 may reduce vibration and noise relative to other drive mechanisms. However, it will be appreciated that other drive mechanisms are possible, such as chain drives, direct drive, gear drives of various configurations, and the like.

In some embodiments, a separate fan motor 1500 independent from the drum motor is used to rotate blower/fan 180. In some embodiments, there may be a built-in motor in blower/fan 180. In some embodiments, one single motor 1500 may be configured to drive both drum 190 and blower/fan 180 via suitable mechanical connections. Some embodiments may include a decoupling mechanism capable of allowing a single motor 1500 to rotate one of drum 190 and blower/fan 180 with the other kept stationary when decoupled, while also allowing single motor 1500 to rotate both drum 190 and blower/fan 180 when coupled.

In some embodiments, motor(s) 1500 may operate using sinusoidal waveforms, which may reduce electrical noise. In some embodiments, other waveforms may be used for operating motor 1500, such as square waves or trapezoidal waveforms, and the like.

As depicted particularly in FIGS. 7 and 8, in some embodiments, drum 190 comprises one or more discs 1700. As drum 190 rotates, discs 1700 may become partially submerged in basin 1000, thereby becoming wet with the fluid in basin 1000. As air is drawn between discs 1700 via blower/fan 180, fluid may be evaporated and expelled into the surroundings of humidifier 100.

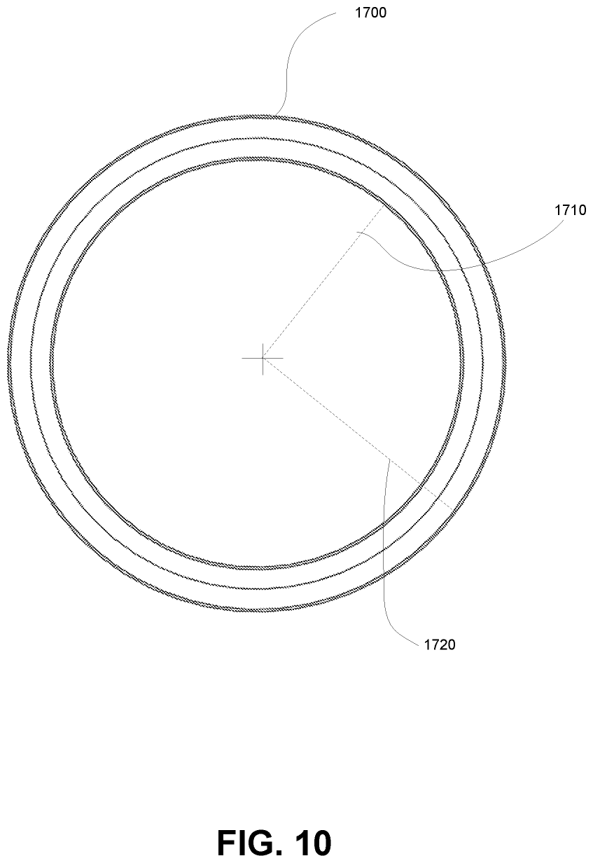

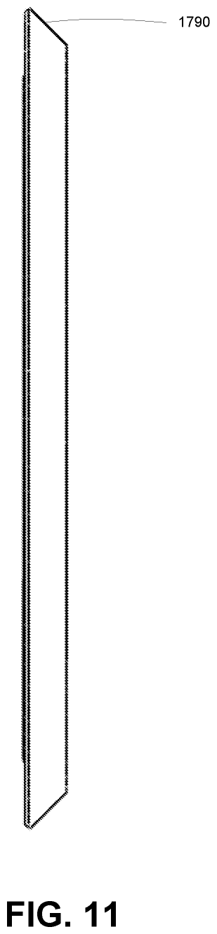

In some embodiments, the fluid level in basin 1000 may be maintained at a predetermined level. In some embodiments, the fluid level in basin 1000 may be maintained at an optimum level for wetting discs 1700 as they are rotated. In some embodiments, discs 1700 may be made of plastic. In some embodiments, discs 1700 may be made of one or more of stone, stainless steel, aluminum, clay, biscuit porcelain, porous plastic, and/or glass. In some embodiments, plastic discs may be one or more of flame, plasma, and/or chemically treated, and/or roughened to increase surface energy to cause an increased quantity of fluid to adhere to discs 1700. FIGS. 10, 11 and 12 provide various views of an individual disc 1700.

In some embodiments, drum 190 includes a plurality of discs 1700. In some embodiments, discs 1700 may be stacked along a horizontal axis of rotation. In some embodiments, the space between stacked discs may be optimized. In some embodiments, the spacing distance between discs may be 1 mm to 100 mm. In some embodiments, a variable spacing between discs may be used to ensure substantially uniform air flow to all of discs 1700. In some embodiments, spacers may be used to achieve a desired spacing distance between discs 1700. In some embodiments, discs 1700 may be arranged parallel to one another.

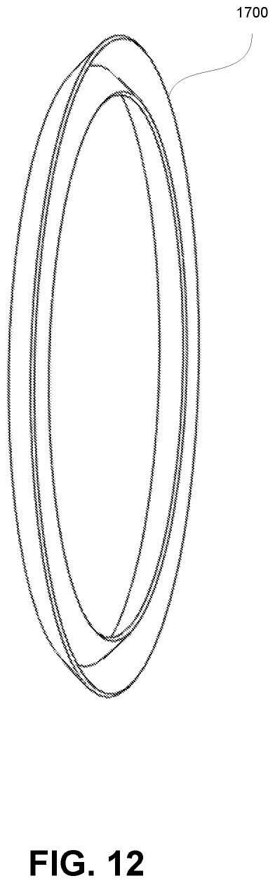

In some embodiments, as depicted in FIG. 12, discs 1700 may be profiled so as to allow close and efficient stacking along the axis of rotation. In some embodiments, the profile of discs 1700 may be designed to reduce the stagnant boundary layer of air on the surface of the discs 1700, maximizing evaporation while minimizing or reducing airflow restrictions (e.g. by adjusting an angle 1790 or providing a curvature rather than a straight line, optimizing spacing of discs 1700, and/or optimizing a ratio of the inner radius to the outer radius of the discs), and/or ensuring discs 1700 are easy and simple to clean and/or maintain. As depicted in FIGS. 10-12, individual disc 1700 has an inner radius 1710 and an outer radius 1720. In some embodiments, the ratio of inner radius 1710 to outer radius 1720 may be selected to optimize the wetted surface area without impairing airflow. In some embodiments, the ratio of inner radius to outer radius may be 0.33 to 0.9. In some embodiments, the ratio of inner radius to outer radius may be 0.33.

In some embodiments, the shape of disc 1700 may ensure that when air is drawn through air inlet 120, the dry air hits the discs 1700 substantially perpendicularly to the surface of discs 1700. In some embodiments, when air flows parallel to the discs 1700, this may result in a stagnant boundary layer and reduced evaporation efficiency. The stagnant boundary layer issue may be less of a concern on HVAC mounted units, in which blowers are significantly larger and more powerful. Studies have shown that the evaporation rate may double when air flow is perpendicular to a surface compared to air flowing parallel (for example, one might conceptualize a blow dryer drying a plate dead-on vs. at an angle/parallel). In some embodiments, a “V” shape for disc 1700 may provide a second perpendicular location for the air to collide with a surface, thereby increasing air turbulence, minimizing the stagnant boundary layers, and thus maximizing disc drying. In some embodiments, additional colliding surfaces (for example, additional 90 degree bends, a W-shaped profile) can be added. However, these may increase the pressure drop across the discs 1700 and may cause additional noise because the fan may need to work harder. In some embodiments, discs 1700 may include smooth curves. However, smooth curves may be more difficult to clean

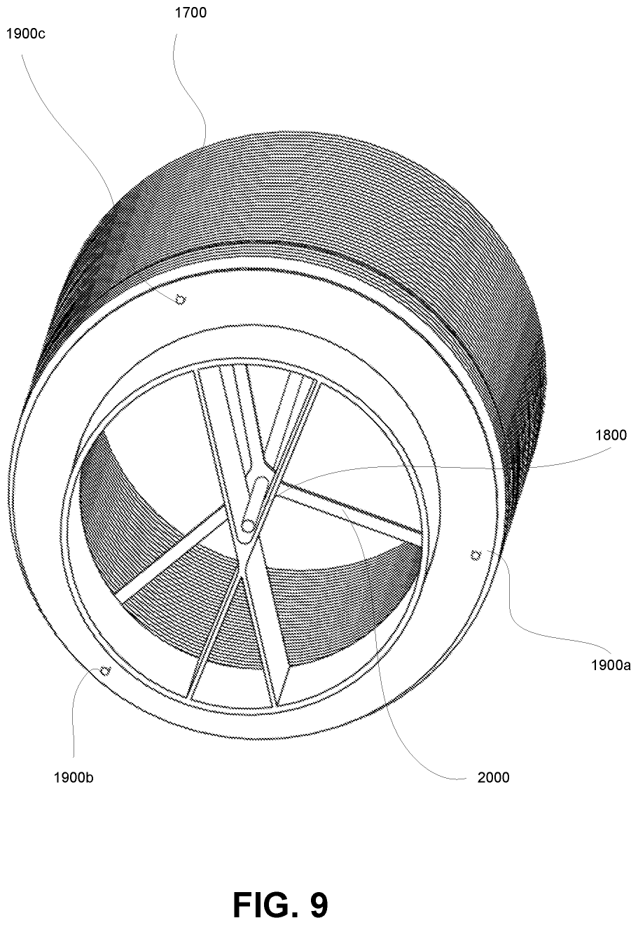

As depicted in FIG. 9, one or more shafts 1900 may be used to align and/or connect a plurality of discs 1700. As depicted in FIG. 9, three disc-connecting shafts 1900a, 1900b, 1900c may ensure alignment and rotation of discs 1700. It will be appreciated that in other embodiments, more shafts 1900 than 3 or less shafts than 3 are contemplated. In some embodiments, discs 1700 may be connected via main drum shaft 1800 along the main axis of rotation. As depicted in FIG. 9, in some embodiments, a 3-spoke component 2000 connects main shaft 1800 to shafts 1900. In some embodiments, a circular plate (as depicted in FIG. 8) may connect main shaft 1800 and shafts 1900 to prevent air from circumventing the desired flow path. In some embodiments, main shaft 1800 may rest and spin feely within air inlet 120.

In some embodiments, as drum 190 is rotated, a lower portion of discs 1700 is submerged in fluid within basin 1000 and subsequently rotated up and out, while subsequent portions of discs 1700 are then submerged. As wetted discs 1700 are rotated, fan 180 may draw air in via inlet 120 and expel the air via outlet/exhaust 130. It will be appreciated that the air drawn in via inlet 120 is passed through the rotating discs 1700, which imparts humidity to the air, which humidified air is expelled via outlet/exhaust 130, thereby humidifying the surroundings of humidifier 100.

In some embodiments, there may be minimal flow path disruptions within the humidifier, which may allow the fan/blower 180 to operate efficiently and quietly. In some embodiments, fan/blower 180 may be a high static pressure fan/blower. A high static pressure blower/fan may offer advantages in terms of a reduced ratio of noise to amount of cubic feet per minute (CFM) of air, relative to other fan types (e.g. axial fans) at a specific static pressure. In some embodiments, blower/fan 180 may be located on the outlet side of humidifier 100 in a draw-through configuration (rather than the inlet side in a blow-through configuration), which may provide better circulation of humid air into the surroundings, and/or may prevent or reduce the amount of humid air being recirculated back into humidifier 100 via inlet 120.

During operation of humidifier 100, fluid drawn by discs 1700 may reduce the fluid level in basin 1000, which may trigger float valve 1400 to allow fluid from reservoir 160 to flow to basin 1000. As such, reservoir 160 may become depleted over time. Users may add more fluid to reservoir 160 to replenish the fluid supply.

When the fluid used is hard water (i.e. water with high levels of dissolved minerals), solids may start to precipitate. In some embodiments, to prevent accumulation of mineral deposits in basin 1000, basin 1000 may be drained via basin drain 1300. Thus, fluid in basin 1000 may be drained into an external catch basin and disposed of, thereby allowing a fresh batch of fluid to flow from reservoir 160 to fill basin 1000. In some embodiments, refilling basin 1000 with fresh fluid (e.g. clean water) may help minimize or reduce stagnant water and reduce the potential for mold and/or bacteria to build within basin 1000. In some embodiments, basin 1000 may be drained on a weekly basis. It will be appreciated that the frequency with which basin 1000 is drained for ideal operation will depend at least in part on how many hours per day humidifier 100 is being used as well as the concentration of minerals in the fluid being added to the reservoir 160.

In some embodiments, a more thorough cleaning may be performed. In one example embodiment, a more thorough cleaning may include draining basin 1000 and adding vinegar (i.e. a solution of acetic acid) to reservoir 160. In some embodiments, reservoir 160 may include a “clean” fill line denoting the appropriate level of vinegar required to adequately fill the basin for cleaning. Vinegar, which is ubiquitous and low-cost, may break down any mineral deposits adhering to basin 1000 and/or surfaces of discs 1700, as well as kill any bacteria present. It will be appreciated that although this disclosure includes specific examples involving vinegar, the use of other cleaning and/or disinfecting agents is contemplated.

In some embodiments, humidifier 100 may be configured to include a “clean mode”. In clean mode, drum 190 may rotate discs 1700 through vinegar-filled basin 1000 without fan/blower 180 running. Keeping fan/blower 180 turned off during clean mode may be beneficial in that the smell of vinegar (which may be undesirable to some) is less likely to permeate the surroundings of humidifier 100. In some embodiments, clean mode may be programmed to be performed for a predetermined or set amount of time. For example, in some embodiments 2 to 3 hours may be sufficient, though this quantum of time ultimately depends on the amount of mineral buildup present.

Once a cleaning cycle is complete, basin 1000 may be drained of the vinegar via basin drain 1300. In some embodiments, the vinegar may be collected for re-use. A user may determine whether vinegar may be suitable re-used by determining the pH of the vinegar after the clean cycle. As the pH of the vinegar neutralizes and approaches 7, the vinegar will be less and less suitable for breaking down hard water mineral deposits.

In some embodiments, after draining the vinegar from basin 1000, fresh fluid (e.g. fresh water) may be added to reservoir 160. Clean mode may then be entered again, which may rinse any residual vinegar from discs 1700 and basin 1000, thereby reducing any odours associated with vinegar or other cleaning agents. Once the second cleaning cycle has been conducted with fresh water, basin 1000 may be drained again, and fresh water may then be added to reservoir 160. Humidifier 100 may then be considered to be refreshed and ready for regular operation once again.

It should be appreciated that the cleaning cycles described above are substantially easier and require far less expertise than maintenance associated with conventional humidifier types. Thus, some embodiments described herein are substantially easier and less expensive to maintain.

In some embodiments, a deep cleaning may be conducted. Such deep cleaning may be conducted substantially less frequently than the above-noted cleaning cycle. In a deep cleaning, the assembly of discs 1700 in drum 190 may be separated and cleaned (e.g. with a brush or other cleaning implement). In some embodiments, basin 1000 may also be cleaned with a detergent. In some embodiments, blower/fan 180 may be easily removable and can be wiped clean of any dirt and grime which has accumulated.

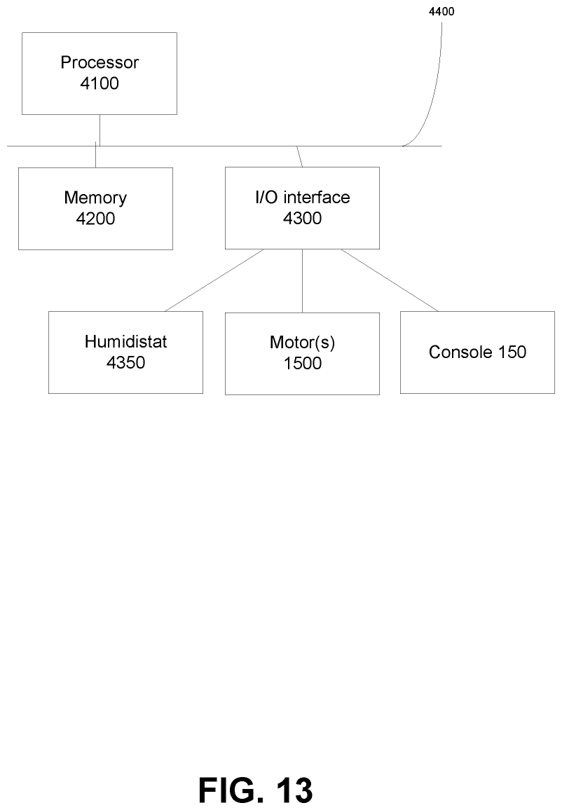

In some embodiments, humidifier 100 includes a computing system 4000. As depicted in FIG. 13, an example computing system may include, for example, processor 4100, memory 4200, input/output interface 4300, console 150, and bus 4400. Console 150 may include, for example, a display panel which displays the currently detected humidity in the vicinity of humidifier 100. In some embodiments, the display panel may include one or more 7-segment displays. In some embodiments, display panel may include an LCD panel. In some embodiments, console 150 may include one or more buttons. Buttons may be used, for example, to control one or more of fan/blower 180 speed, and target humidity (i.e. setpoint) settings.

In some embodiments, a humidistat 4350 may be configured to detect humidity and transmit a signal to I/O interface 4300. In some embodiments, processor 4100 may be configured under control of computer-readable instructions stored in non-transitory computer-readable memory 4200 to compare a target humidity to the humidity level detected by humidistat 4350. In some embodiments, processor 4100 may be configured to determine whether to activate the motor(s) 1500 controlling fan/blower 180 and drum 190 based on the difference between the currently detected humidity level and the target humidity (i.e. setpoint) set by the user of humidifier 100. In some embodiments, processor 4100 may be configured to activate or deactivate motor(s) 1500 irrespective of the currently detected and target humidity. For example, a user may control actuation of individual motor(s) 1500 through use of a smart plug or application.

In some embodiments, when the relative humidity setpoint has been reached, processor 4100 may generate a signal for deactivating the motor 1500 powering blower/fan 180. In some embodiments, when the relative humidity setpoint has been reached, processor 4100 may generate a signal for continuing rotation of the motor 1500 which controls rotation of drum 190. In some embodiments, maintaining rotation of drum 190 may maintain discs 1700 in a substantially fully wetted state, which may reduce the likelihood of mineral deposits from forming on and/or sticking to the surface of discs 1700. In some embodiments, processor 4100 may generate a signal for deactivating motor 1500 powering blower/fan 180 irrespective of the relative humidity setpoint or currently detected humidity levels.

In some embodiments, humidifier 100 may function as a high-efficiency cooling device. For example, in warmer climates, indoor spaces commonly become hotter throughout the day, and it is desirable to cool indoor spaces at night for comfort. In some embodiments, air inlet 120 may be connected to a window (or any source of cooler air), and fan/blower 180 may draw in said cool air and expel cool air via outlet/exhaust 130. As a result of the latent heat of vaporization of water together with cool air, energy consumption of the cooling device configuration of humidifier 100 is drastically reduced compared to traditional compressor-based air conditioning units. Moreover, the noise generated by humidifier 100 would be drastically reduced relative to traditional compressor-based air conditioning units.

Some embodiments described herein may offer numerous benefits and advantages over conventional devices. For example, some embodiments of humidifier 100 may operate at near silent operation, even when operating at maximum power. As such, humidifier 100 may be used in areas without impacting the user's enjoyment of that space (e.g. without impacting quality of sleep, without requiring increased television volume to drown out the noise from other humidifier designs). Moreover, in some embodiments, driving drum 190 using a belt 1600 may minimize vibrations from motor 1500 from being transferred to drum 190, and may reduce the amount of grime accumulating on motor 1500. Further, the fan/blower 180 can be configured to remain off during cleaning mode, which may prevent the smell of cleaning agents from permeating the surroundings of humidifier 100.

Some embodiments of humidifier 100 may further offer hassle-free and inexpensive maintenance, particularly in areas with hard water. The above-noted cleaning cycle and drain 1300 may allow for easy and simple removal of mineral deposits and easy replacement of water in basin 1000. Discs 1700 may also be accessible for deep cleaning if necessary.

Some embodiments may minimize or reduce water usage. The separate reservoir 160 draining into basin 1000 via float valve 1400 may result in fresh water being substantially constantly supplied to basin 1000 during operation, which ensures that water being evaporated is fairly clean, rather than stagnant water which has remained in basin 1000 for a long period of time. Other furnace mounted humidifier designs typically have water constantly flowing through them to address hard water issues, whereas embodiments described herein allow for the user to drain basin 1000 when necessary, rather than wasting water constantly.

Of course, the above described embodiments are intended to be illustrative only and in no way limiting. The described embodiments are susceptible to many modifications of form, arrangement of parts, details and order of operation. Moreover, combinations of various embodiments are contemplated and within the scope of the invention. For example, it is contemplated that different embodiments of temperature sensing circuits described herein (with potentially different insulation and wiring configurations) may be combined with different embodiments of heating circuits described herein. The invention is intended to encompass all such modification within its scope, as defined by the claims.

What is claimed is:

1. A system comprising:
a reservoir containing fluid;
a basin fluidly connected to said reservoir;
a drum partially submerged in said basin, said drum comprising a plurality of discs;
a drum motor configured to rotate said drum and said plurality of discs;
a fan configured to intake air via an inlet and expel air via an exhaust, said drum being positioned between said inlet and said exhaust; and
a fan motor configured to actuate said fan.

2. The system of claim 1, wherein a float valve controls flow of said fluid from said reservoir to said basin.

3. The system of claim 1, wherein said fluid is tap water.

4. The system of claim 1, wherein said first motor is connected to said drum via a belt drive.

5. The system of claim 1, wherein said fan is a static pressure fan or blower.

6. The system of claim 1, wherein said basin comprises a basin drain for draining said basin.

7. The system of claim 1, wherein said reservoir comprises a reservoir drain for draining said reservoir.

8. The system of claim 1, wherein said drum rotates about a substantially horizontal axis.

9. The system of claim 1, wherein said discs are spaced apart by a distance.

10. The system of claim 1, further comprising a controller configured to compare a target humidity value to a detected humidity value detected by a sensor.

11. The system of claim 10, wherein said controller is further to configured to deactivate said fan motor and maintain rotation of said drum motor.

12. A method of humidifying an area, the method comprising:
rotating, via a drum motor, a drum comprising a plurality of discs within a basin, said drum partially submerged within a fluid in said basin;
activating a fan, via a fan motor, to pass air through said plurality of discs to an exhaust.

13. The method of claim 12, wherein the fluid is tap water.

14. The method of claim 12, further comprising controlling flow of said fluid from a reservoir to said basin via a float valve.

15. The method of claim 12, further comprising deactivating said fan motor and maintaining rotation of said drum motor.

16. The method of claim 12, further comprising:
deactivating said fan motor;
draining said fluid from said basin;
at least partially filling said basin with vinegar; and
rotating, via said drum motor, said drum partially submerged in said vinegar.

17. The method of claim 16, further comprising:
draining said vinegar from said basin; and
at least partially filling said basin with a first batch of fresh fluid.

18. The method of claim 16, further comprising draining said fresh fluid from said basin; and at least partially filling said basin with a second batch of fresh fluid.
